(19) United States
(12) Patent Application Publication
(10) Pub. No.: US 2018/0251204 A1
(43) Pub. Date: Sep. 6, 2018

(54) METHOD FOR FILTERING SEAWATER ONBOARD A SHIP

(71) Applicant: GEA MECHANICAL EQUIPMENT GMBH, Oelde (DE)

(72) Inventors: Peter KLOMFAS, Oelde (DE); Heiko SIMS, Tostedt (DE)

(21) Appl. No.: 15/755,626

(22) PCT Filed: Aug. 17, 2016
(86) PCT No.: PCT/EP2016/069529

§ 371 Date: Feb. 27, 2018

(30) Foreign Application Priority Data
Aug. 31, 2015 (DE) 10 2015 114 473.5

(51) Int. Cl. B63J 4/00; B01D 29/60; C02F 1/00; B01D 35/157

(52) U.S. Cl. CPC B63J 4/002; B01D 29/606; C02F 2103/008; B01D 29/603; B01D 35/1573; C02F 1/001

(57) ABSTRACT

A method for filtering seawater onboard a ship involves pumping seawater into a filtration device so that the seawater is introduced into the filtration device at an inlet pressure, flows in the filtration device through a filter element, and after the filter element as filtered seawater has an outlet pressure. A concentrate phase or concentrate removed using the cleaning device at the filter element of the filtration device is carried away from the filter element and has a concentrate pressure. The inlet pressure, the outlet pressure, and the concentrate pressure are measured. A change in filter efficiency of the filter element is recognized by determining a change in a contamination pressure difference between the inlet pressure and the outlet pressure and/or a suction pressure difference defined as the difference between the outlet pressure and the concentrate pressure is controlled depending on the contamination pressure difference.

### BACKGROUND AND SUMMARY OF THE INVENTION

Exemplary embodiments of the invention relate to a method for filtering seawater, in particular onboard a ship.

Seawater taken onto ships as ballast water from a body of water contains numerous impurities and living organisms such as bacteria, seaweed, plants etc. Current environmental regulations therefore require that ballast water, which has been taken onboard, be purified, for example filtered, and then optionally additionally be subjected to UV irradiation and/or ultrasonication before it can be transferred as purified ballast water into ballast water tanks provided for this purpose.

Such a filter apparatus is known, for example, from German patent document DE102009054387 A1 or WO 2011 064 260 A1. This apparatus has the disadvantage that a relatively large quantity of water is flushed out together with the concentrate and does not reach the ballast water tank.

In view this background, exemplary embodiments of the invention provide an efficient method for filtering seawater, which may then be subjected to a post-treatment such as UV irradiation and is then usable as ballast water.

Exemplary embodiments of the invention implement an adaptive filter control measure that always adapts filter cleaning to actually prevailing requirements. Filtration reliability is greatly improved as a result and at the same time the flow of filtrate to the ballast water tanks is maximized.

Monitoring the state of contamination of a filter by establishing the differential pressure (pressure in the filter inlet minus pressure in the filter outlet) is indeed already known per se, for example from German patent document DE10 2006 045 558 A1 or PCT International patent document WO 2007 130 029 A1. These documents disclose that exceeding a differential pressure limit value is used to flush the filter clean again by reversing the flow direction of the medium to be filtered. This procedure has the disadvantage that the filtration process or filtering method has to be interrupted while the backflushing is to be carried out for example with the assistance of appropriate valves and pipework. In contrast, exemplary embodiments of the invention take a more advantageous approach.

### BRIEF DESCRIPTION OF THE DRAWING FIGURES

The invention is described below by way of exemplary embodiments with reference to the drawings, in which:

FIG. 1 is a schematic diagram of an installation for filtering ballast water;

FIG. 2 is a schematic diagram of part of a second installation for filtering ballast water; and

FIG. 3 is a table to illustrate an exemplary implementation of a method according to the invention.

### DETAILED DESCRIPTION

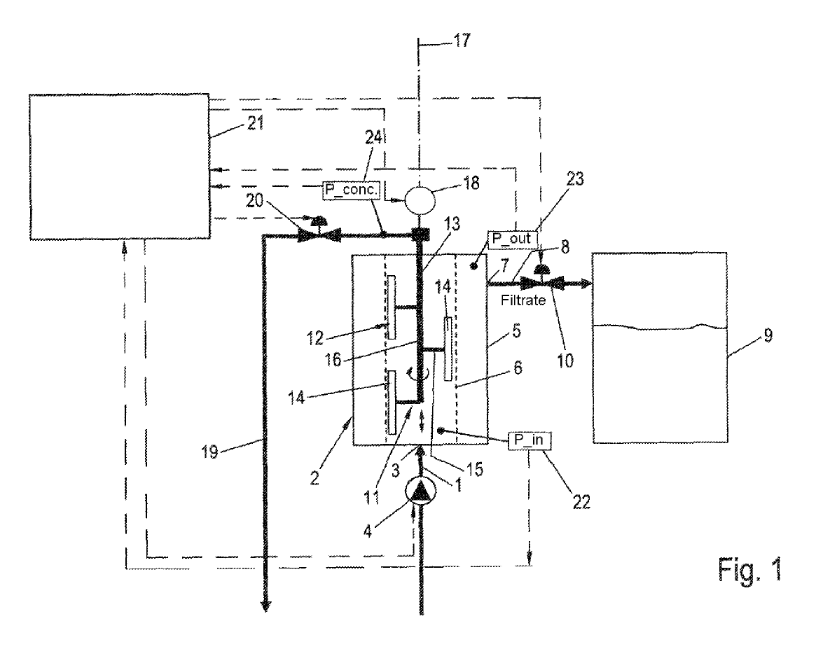

The installation of FIG. 1 comprises an inlet line 1 through which seawater can be pumped onboard a ship from a body of water, for example an ocean or a river or a canal. The inlet line 1 opens at an inlet 3 into a filtration apparatus 2. The inlet line 1 includes a pump 4 with which the water can be taken onboard, then conveyed into the filtration apparatus 2 and preferably onward through the latter into further parts of the installation.

The filtration apparatus comprises a tank 5 in which a cylindrical filter element 6 is arranged. The inlet 3 opens into the tank 5 at one end of the tank 5 in such a manner that the seawater which is pumped with the pump 4 into the tank 5 from the body of water (not shown) is passed into the interior of the cylindrical filter element 6. In the filtration device 2, the seawater flows through the filter element 6, wherein a “contaminant phase” of contaminant particles and living organisms together with a fraction of seawater is separated as a concentrate. The purified seawater flows through the filter element from the inside outwards and forms the filtrate. Optionally after having passed through further purification stages, the water is usable onboard the ship as ballast water.

An outlet 7 from the tank 5 for the filtered ballast water is located radially outside the filter element 6. An outlet line 8 is provided at the outlet 7, with which line the filtered ballast water can be passed directly or via further purification stages (for example one or more filtration stages and/or an irradiation stage or the like) into at least one ballast water tank 9 for filtered ballast water. The outlet line 8 includes a preferably actuatable control valve 10 that can be used to vary the cross-section of the outlet line 8.

A cleaning device 11 is preferably arranged within the cylindrical filter element 6. The cleaning apparatus 11 is designed to detach contaminants from the filter element 6 and to discharge, in particular aspirate, a contaminant concentrate phase consisting of water and the contaminants from the filter element 6. To this end, the cleaning apparatus comprises a means 12 for cleaning the filter element 6, a drive 18 (preferably a motor) for moving the means 12 on the filter element 6 and a discharge line 13 for discharging the contaminant concentrate phase.

According to FIG. 1, in a preferable and advantageous development, the cleaning apparatus 11 comprises as the means 12 one or more aspiration elements 14, which in an advantageous development are in particular brush-like, which elements are arranged via arms 15 on a rotatable shaft 16. The shaft 16 is preferably aligned with a center axis/axis of symmetry 17 of the cylindrical filter element 6. The arms 15 are preferably radially oriented. The aspiration elements 14 preferably rest against the inside of the filter element 6.

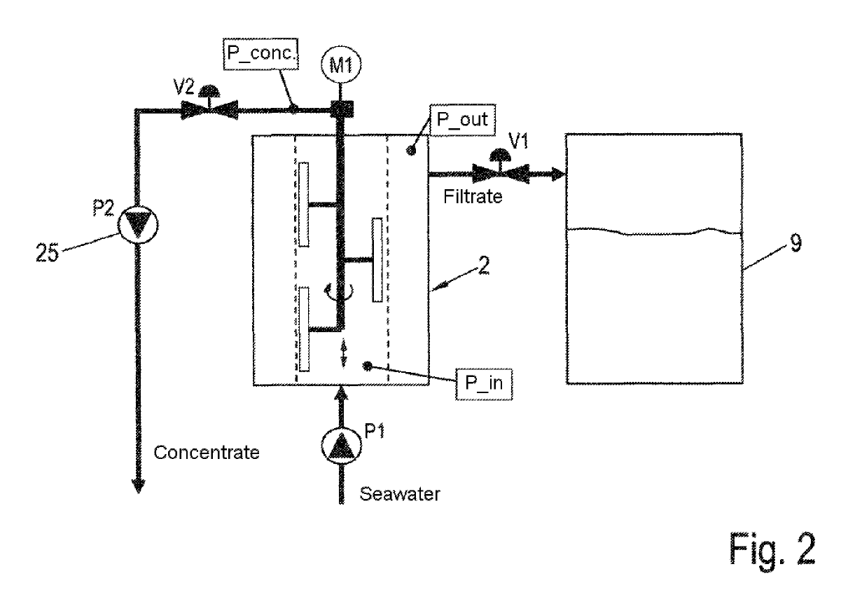

A drive 18 serves to rotate the shaft 16. When the shaft 16 is rotated, the aspiration elements 14 move along on the inside surface of the filter element 6 and clean the latter of contaminant particles which they detach and aspirate there. In addition, displacement of the aspiration elements 14 and/or the shaft 16 may be provided, in particular in the axial direction, in the tank, to allow the filter element 6 to clean the entire inner surface. Alternatively, the aspiration elements 14 can overlap axially if they are arranged at an angular offset (viewed in the circumferential direction of the shaft 16). An aspiration pump 25 (FIG. 2) may optionally be included in the discharge portion 19 of the discharge line 13. Alternatively, or in addition, the pump 4 may also develop the pressure with which the concentrate is conveyed through the discharge line 13. The term “aspiration elements” 14 should not in this respect be understood too narrowly but instead describes the fundamental suitability for use of these elements optionally also with an aspiration pump 25 downstream thereof.

Contaminants are detached onto/with the aspiration elements 14 and, together with a seawater fraction, passed as a concentrate or contaminant phase out of the tank 5 through the arms 15 or lines on the arms and through the shaft 16 or a line on the shaft 16. A line portion 19, which is downstream of the shaft 16, of the discharge line 13 here disposes of the contaminant phase, for example in a disposal area (not shown). It is desirable for the smallest possible fraction of seawater to be present in the contaminant phase.

An actuatable control valve 20 and/or the previously mentioned speed-controlled aspiration pump 25 (FIG. 2) may be arranged in the discharge line 13, in particular in the discharge portion 19. An open-loop (and closed-loop) control apparatus 21, not shown in FIG. 2 but also provided there, serves for open- and closed-loop control of the installation. The control apparatus may be connected wirelessly, by a bus system or via lines, here shown in dashed lines, with components of the installation, for instance with the control valves 10 and 20, the drive 18, the pump 4, optionally the optional aspiration pump 25 and preferably with sensors 22, 23, 24, for instance with sensors for measuring pressures.

The sensors 22, 23, 24 in particular sense the following pressures:

sensor 22: an inlet/input pressure P_in within the filter element 6,

sensor 23: a filtrate outlet pressure/output pressure of the filtrate or ballast water P_out outside the filter element 6; and

sensor 24: a concentrate pressure P_conc. (concentrate) in the discharge line 13.

The sensors 22, 23, 24 or corresponding pressure transmitters for P_in, P_out and P_conc. may be mounted in the filter tank 5 within and outside the filter element 6 or in adjoining (pipe)lines (inflow lines or outflow lines 1, 8, 13).

Advantageous methods for filtering seawater taken from a body of water in order to obtain ballast water can be implemented using the installation shown.

The following parameters are here established with the control apparatus:

contamination pressure difference ΔP_{F}:=P_in−P_out; and

aspiration pressure difference ΔP_{K}:=P_out−P_conc.

In particular, a method for filtering seawater onboard a ship for obtaining ballast water is thus implemented with the filtration device 2, which comprises the, in particular, cylindrical filter element 6 arranged in the tank 5 and the cleaning apparatus 11 for detaching contaminants from the filter element 6 and for discharging the concentrate phase consisting of water and the contaminants from the filter element and from the filtration device 2; with the following steps:
a) seawater is pumped into the filtration device 2;
b) the seawater is passed with an input pressure P_in into the filtration device 2, flows in the filtration device 2 through the filter element 6 and, downstream of the filter element 6, has an output pressure P_out as filtered seawater (filtrate);
c) a concentrate phase removed with the cleaning apparatus 11 at the filter element 6 of the filtration device 2 and discharged from the filter element 6 has a concentrate pressure P_conc.;
d) the input pressure P_in, the output pressure P_out and the concentrate pressure P_conc. are measured with sensors (22, 23, 24) and the measured pressures are transmitted to a control device (21);
e) a change in filter efficiency of the filter element (6) is identified in that a change of a contamination pressure difference ΔP_{F}=P_in−P_out between the input pressure P_in and the output pressure P_out is established; and/or
f) an aspiration pressure difference ΔP_{K}=P_out−P_conc. defined as a difference between the output pressure and the concentrate pressure is controlled as a function of the contamination pressure difference ΔP_{F}=P_in−P_out.

A change in filter efficiency is here simply identified in that a change in contamination pressure difference ΔP_{F} is established.

The contaminant particles or contaminant phase and some of the seawater are preferably and structurally simply aspirated on the inner side of the filter element 6 in the tank 5 by means of the aspiration elements 14 which, during operation, are constantly or in any event from time to time in rotation with the shaft 16.

The aspiration elements 14 roll in motor-driven manner on the inner side of the filter element 6. As the contaminant loading of the seawater increases, the load on the filter element 6 also increases and the contamination pressure difference (P_in−P_out) rises. The seawater aspirated by means of the aspiration pressure difference ΔP_{K} is disposed of, for example is passed directly back into the sea, is in this manner lost from the ballast water and thus does not reach the ballast water tanks. This effect should be minimized as far as possible.

One condition for increasing filter efficiency of the filter element 6 consists by definition in a rise in the contamination pressure difference ΔP_{F}.

According to one advantageous variant of the invention, in the event of an increasing contamination pressure difference ΔP_{F}, the aspiration pressure difference ΔP_{K}, and thus the aspirated quantity of water, is raised. This control measure also operates in the reverse direction: in the event of a falling contamination pressure difference ΔP_{F}, the aspiration pressure difference ΔP_{K} and thus the quantity of water aspirated or lost or discharged with the contaminant phase is reduced. In this case, the loss of water due to the aspirated water is reduced and the efficiency of the method or installation increases. As a consequence, the time required for ballasting is shortened.

The aspiration pressure difference ΔP_{K} is preferably adjusted as a function of the contamination pressure difference ΔP_{F}, in particular in a range from 0 to 5 bar, preferably 1.2-2.2 bar, since these values have proved particularly advantageous for efficient operation of the installation.

It is furthermore advantageous if, according to a further variant of the invention, the frequency of aspiration (f motor) per m² filter area is raised in order to reduce the contamination pressure difference ΔP_{F}. This means that the motor speed of the drive 18 or the shaft 16 is modified or adapted. In this method variant, an increasing contamination pressure difference ΔP_{F} accordingly leads to an increase in rotational speed of the shaft 16 and vice versa. The mechanical load on the aspiration elements 14 is adapted to the actual requirement. Unnecessary wear is avoided. In addition, or alternatively, the volumetric flow rate [m³/h] aspirated with the aspiration pump 25, if present, may be raised and/or the control valve 20 opened wider.

The rotational speed of the shaft 16 or thus of the aspiration elements 14 is set at a rotational speed of between 0 and 100 rpm, preferably between 12 and 50 rpm.

According to a further advantageous variant of the invention, the volumetric flow rate (filtrate flow) of seawater through the filter element 6 of the filtration device 2 is reduced if the contamination pressure difference ΔP_{F} exceeds an upper limit value (of for example 1.1 bar). The described control measures on the valves 10, 20 and/or an aspiration pump 25 and/or a rotational speed of the shaft 16 are then already running at the maximum values. The volumetric flow rate [m³/h] is reduced until the contamination pressure difference ΔP_{F} falls below a lower limit value (for example 0.9 bar). The volumetric flow rate [m³/h] and thus the filter load are consequently adapted to the maximum possible filter cleaning and clogging of the filter element 6 is prevented. It is ensured that intake of ballast water need not be interrupted if the water has a very high contaminant loading.

The maximum or possible volumetric flow rate [m³/h] may optionally be raised, in particular in steps, by parallel connection of further filtration devices 1 or filter inserts 6 in the tank 5.

The aspiration pressure difference ΔP_{K} is preferably increased by means of modifying the cross-section in the discharge line 13 by opening the control valve 20. Should this prove insufficient, the pressure P_conc. is optionally additionally further reduced, in particular in the discharge portion 19 for the concentrate, with the preferably speed-controlled aspiration pump 25, see FIG. 2.

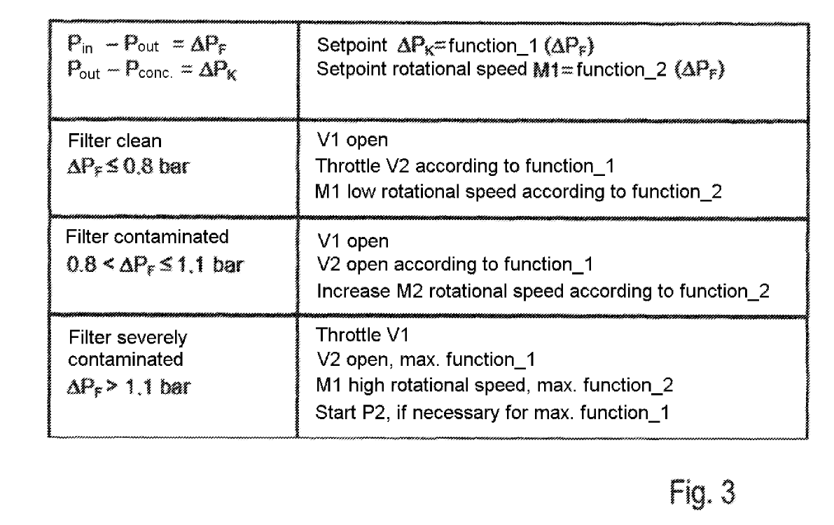

In FIGS. 2 and 3, the drive 18 is denoted M1, the pump 4 denoted P1, the aspiration pump 25 denoted P2, the control valve 10 denoted V1 and the control valve 20 denoted V2. The sensors 22, 23 and 24 are shown in simplified form only by the measured values P_in, P_out and P_conc. Unlike in the exemplary embodiment according to FIG. 1, the exemplary embodiment of the installation according to FIG. 2 comprises the concentrate pump (suction pump) 25 or P2.

By way of example, the method according to the invention is here implemented with regard to steps e) and f) as illustrated in FIG. 3.

According thereto, the contamination pressure difference is again denoted ΔP_{F}=P_in−P_out and the aspiration pressure difference is denoted ΔP_{K}=P_out−P_conc.

The state ΔP_{F}<=0.8 bar is denoted “filter clean” or “filter element clean”. Control valve V1 is open, valve V2 is throttled to reduce concentrate discharge and a low rotational speed is set for the drive M1 for the shaft 16.

The state 0.8 bar <ΔP_{F}<=1.1 bar is denoted “filter contaminated” or “filter element contaminated”. Control valve V1 is open, valve V2 is opened wider to increase concentrate discharge and a higher rotational speed is set for the drive M1 for the shaft 16.

The state ΔP_{F}>1.1 bar is denoted “filter severely contaminated” or “filter element severely contaminated”. In order to avoid overloading the filter element, control valve V1 is throttled, valve V2 is opened to increase concentrate discharge and a higher rotational speed is set for the drive M1 for the shaft 16. If necessary, aspiration pump P2 may additionally be started in order to raise concentrate discharge further.

The actual increase or reduction may be achieved by pre-stored functions or functional interrelationships which have been established by testing. In this manner, interrelationships ΔP_{K}=function_1 (ΔP_{F}) and rotational speed M1=function_2 (ΔP_{F}) may be established which are then used for adjustment/control in the stated ΔP_{F} states.

### REFERENCE SIGNS

Inlet line 1
Filtration apparatus 2
Inlet 3
Pump 4
Tank 5
Filter element 6
Outlet line 7
Discharge line 8
Ballast water tank 9
Control valve 10
Cleaning device 11
Means 12
Discharge line 13
Aspiration elements 14
Arms 15
Shaft 16
Center axis/axis of symmetry 17
Drive 18
Discharge portion 19
Control valve 20
Control apparatus 21
Sensors 22-24
Concentrate pump 25

1-12. (canceled)

13. A method for filtering seawater onboard a ship with a filtration device, which comprises a cylindrical filter element arranged in a tank and a cleaning apparatus for detaching contaminants from the filter element and for discharging a contaminant concentrate phase consisting of water and the contaminants from the filter element and from the filtration device, the method comprising:
a) pumping seawater into the filtration device;
b) the seawater is passed with an input pressure P_in into the filtration device, flowing the seawater in the filtration device through the filter element and, downstream of the filter element, has an output pressure P_out as filtered seawater or filtrate;
c) a concentrate phase or concentrate removed with the cleaning apparatus at the filter element of the filtration device and discharged from the filter element has a concentrate pressure P_conc.;
d) measuring the input pressure P_in, the output pressure P_out and the concentrate pressure P_conc. with sensors and transmitting sensor measurements to a control device; and
e) identifying a change in filter efficiency of the filter element based on a change of a contamination pressure difference ΔP_{F}=P_in−P_out between the input pressure P_in and the output pressure P_out, and/or f) controlling an aspiration pressure difference ΔP_{K}=P_out−P_conc., which is defined as a difference between the output pressure and the concentrate pressure, as a function of the contamination pressure difference ΔP_{F}=P_in−P_out.

14. The method of claim 13, wherein the contaminant phase is aspirated on an inner side of the filter insert using aspiration elements that are rotatable with a common shaft, are moved along the inner side of the filter element and with which contaminants are aspirated there from the filter element.

15. The method of claim 13, wherein the aspiration pressure difference ΔP_{K} is reduced responsive to a falling contamination pressure difference ΔP_{F}.

16. The method of claim 13, wherein the aspiration pressure difference ΔP_{K} is raised responsive to an increasing contamination pressure difference ΔP_{F}.

17. The method of claim 13, wherein the aspiration pressure difference ΔP_{K} is adjusted in a range from 0 to 5 bar.

18. The method of claim 17, wherein the aspiration pressure difference ΔP_{K} is adjusted in a range from 1.2-2.2 bar.

19. The method of claim 13, wherein the aspiration pressure difference ΔP_{K} is adjusted as a function of the contamination pressure difference ΔP_{F} in a range from 1.2 to 2.2 bar.

20. The method of claim 13, wherein the aspiration pressure difference ΔP_{K} is controlled by at least one actuation of a control valve in a discharge line for the concentrate from the filtration apparatus.

21. The method of claim 13, wherein the aspiration pressure difference ΔP_{K} is controlled by modifying a pump rotational speed of at least one aspiration pump in a discharge portion for the concentrate.

22. The method of claim 13, wherein the contamination pressure difference ΔP_{F} is controlled by modifying a frequency of aspiration per m² of filter area of the filter element.

23. The method of claim 22, wherein the contamination pressure difference ΔP_{F} is controlled by modifying a rotational speed of a drive of the cleaning apparatus.

24. The method of claim 22, wherein a rotational speed of a shaft for rotating the aspiration elements is set to 2-50 rpm.

25. The method of claim 13, wherein a volumetric flow rate [m³/h] of seawater through the filtration device is reduced with the assistance of a control valve 10 or a controllable pump responsive to the contamination pressure difference ΔP_{F} exceeding an upper limit value, and the volumetric flow rate [m³/h] is reduced until the contamination pressure difference ΔP_{F} falls below a lower limit value.

26. The method of claim 25, wherein the upper limit value is 1.1 bar and the lower limit value is 0.9 bar.
